(19) United States
(12) Patent Application Publication
(10) Pub. No.: US 2020/0274932 A1
(43) Pub. Date: Aug. 27, 2020

(54) SYSTEM AND METHODS FOR EFFICIENTLY TRANSFERRING DATA FROM A COMPUTER MODEL TO A NON-COMPUTER ENVIRONMENT

(71) Applicant: MICHAEL VESSELL, ST. LOUIS, MO (US)

(72) Inventor: MICHAEL VESSELL, ST. LOUIS, MO (US)

(21) Appl. No.: 16/537,085

(22) Filed: Aug. 9, 2019

Related U.S. Application Data
(60) Provisional application No. 62/810,738, filed on Feb. 26, 2019.

(51) Int. Cl. H04L 29/08; G06F 17/50; G06F 3/14

(52) U.S. Cl. CPC H04L 67/125; G06F 2217/12; G06F 3/14; G06F 17/50

(57) ABSTRACT

Systems and methods for quickly and accurately transferring computer-aided design drawings to a non-computer environment to scale. At a high level of generality, the systems and methods described herein use a high-quality projector oriented generally perpendicularly downward towards a workstation surface to project the view to be transposed, scaling the projected image, and then transferring the projected symbols.

### CROSS-REFERENCE TO RELATED APPLICATIONS

This application claims the benefit of U.S. Prov. Pat. App. Ser. No. 62/810,738, filed Feb. 26, 2019, the entire disclosure of which is incorporated herein by reference.

### BACKGROUND OF THE INVENTION

### Field of the Invention

This disclosure is related to the field of engineering, and more particularly to systems and methods for accurately transferring computer-aided drafting information to a non-computer environment.

### Description of the Related Art

Many engineering disciplines use computer-aided design (CAD) software to create, modify, analyze, and optimize the design of engineered products and components. CAD software models a product, typically in three-dimensions in a virtual environment and renders the model on a two-dimensional screen associated with the computer. The user can then use a mouse or other input device to manipulate and modify the design.

In some instances, finishes, the digital drawings may be used to provide instructions to fabrication devices, such as additive manufacturing systems (e.g., “3D printers”) and computer numeric control (CNC) machines to fabricate the products designed using the CAD software.

A common step in fabrication is that the finished CAD drawings have certain views transferred to a fabrication workstation. The workstation is generally a table, bench, or other flat surface where key elements of a CAD view are transferred, to scale, to indicate to the fabricator how to position the components. The process of transferring the drawings is laborious and exacting, requiring that an engineer or designer review the original drawings in detail, to calculate the scale change, and mark the table accordingly. Accuracy and precision are crucial in this process, or the fabrication process will be unsuccessful.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is a method for transferring a computer-aided drawing comprising: providing a workstation having a general planar top surface comprising at least one surface scale symbol; providing a projector disposed at an angle generally perpendicular to said top surface to project light thereon; providing a computer operatively coupled to said projector; at said computer, creating a computer-aided drawing; at said projector, receiving from said computer data indicative of said computer-aided drawing of an object of manufacture having a set of real-world dimensions; said projector projecting a likeness of said computer-aided drawing on said top surface, said projected likeness including at least one projected scale symbol; scaling said projected likeness until the dimensions of said projected likeness on said top surface are about the same as said real-world dimensions of said object of manufacture, by aligning said projected scale symbol to said surface scale symbol; and transferring said scaled projected likeness to said workstation.

In an embodiment of the method, said computer further comprises CAD software and said creating a computer-aided drawing comprises using said CAD software.

In another embodiment of the method, said receiving from said computer data indicative of said computer-aided drawing of an object of manufacture having a set of real-world dimensions comprises receiving a wireless transmission over a network.

In another embodiment of the method, said receiving from said computer data indicative of said computer-aided drawing of an object of manufacture having a set of real-world dimensions comprises receiving data via a wired network.

In another embodiment of the method, said projecting a likeness of said computer-aided drawing on said top surface comprises the use of corrective perspective control.

In another embodiment of the method, said projecting a likeness of said computer-aided drawing on said top surface comprises the use of corrective perspective control.

In another embodiment of the method, said projector is disposed at least 12 feet above said top surface.

In another embodiment of the method, said scaling said projected likeness further comprises adjusting a height of said projector above said top surface.

In another embodiment of the method, said scaling said projected likeness further comprises adjusting said angle of said projector.

In another embodiment of the method, said scaling said projected likeness further comprises adjusting a focus setting of said projector.

### BRIEF DESCRIPTION OF THE DRAWINGS

FIG. 1 depicts an embodiment of a system for transferring visual information as described herein.

FIG. 2 depicts an embodiment of a method for transferring visual information as described herein.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

Described herein, among other things, are systems and methods for transferring computer-aided design drawings to a non-computer environment quickly, accurately, and to scale. At a high level of generality, the systems and methods described herein use a high-quality projector oriented at towards a workstation surface to project the view to be transposed, scaling the projected image, and then transferring the projected symbols.

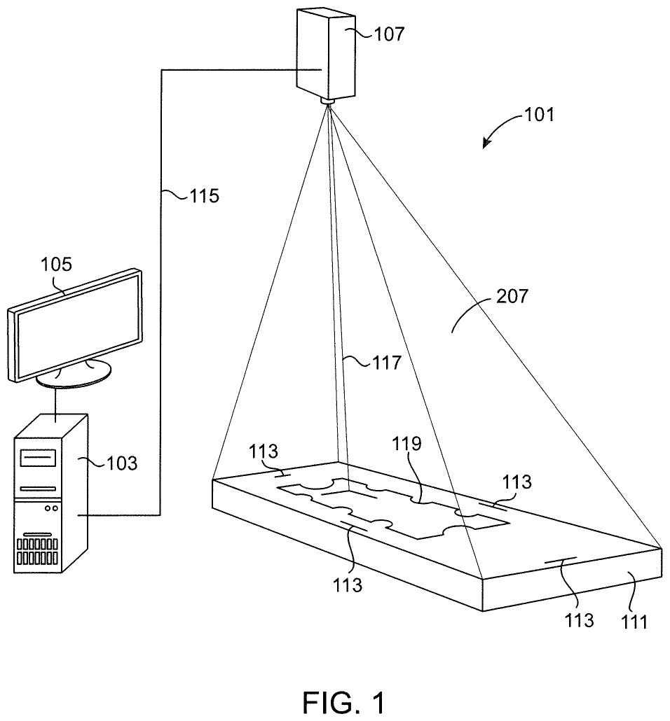

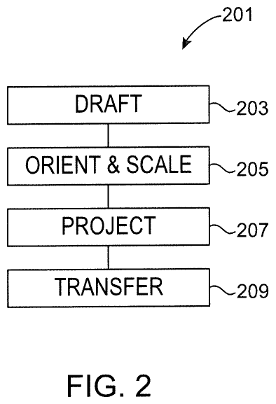

FIGS. 1 and 2 depict non-limiting, exemplary embodiments of systems and methods, respectively, for doing so. As shown in the depicted embodiment of FIG. 1, a computer system (103) having a CAD program is used by a designer to develop a digital design file for a fabricated product or design. The designer drafts (203) the design using the computer system (103) as normal, and views the output on a monitor (105) or other screen associated with the computer system (103).

Once the design is complete and ready for fabrication, the computer is connected (115) to a projector (107). This connection (115) may be by wire or wireless connection, such as over a network. Typically, the computer system (103) is connected (115) to the projector once and the connection (115) is maintained or reconnected as necessary. The projector (107) may be any high-lumens, high-resolution projector (107) capable of projecting the CAD designs at a sufficiently high resolution and brightness for transfer (209) as described elsewhere herein. The particular model of the projector (107) is not normally relevant, but it is preferred to use a projector (107) with corrective perspective control features, such as Keystone correction.

The projector (107) is oriented with respect to a workstation (111) so that when it is powered on and used to project (207) unto the workstation (111), the projected image (119) generally covers the work surface of the workstation (I 11). Typically, a workstation (111) has a planar main work surface oriented so that the plane is perpendicular to gravity. Thus, the projector (107) is normally oriented (205) top-down to project in a direction parallel to gravity such that a main axis (I 17) of projection is about perpendicular to the plane of the workstation (111). The distance from the projector (107) and workstation (111) may vary from embodiment to embodiment, and may depend on factors including the type, brightness, and resolution of the projector (107), the size, surface material, and shape of the workstation (111), and other factors that will be known to a person of ordinary skill in the art. Some ordinary experimentation may be required to determine an optimal or preferred distance. In the depicted embodiment of FIG. 1, the projector (107) is positioned approximately 12 feet above the workstation (111).

An aspect of the present systems and methods is that the projector (107) positioned and orientation is configured such that the projected image scales to the actual dimensions of the modeled product to be fabricated when projected to the workstation (111). This may include a scaling step (205), which is generally part of the process of orientation (205) and positioning (205).

In an embodiment, this may be done, for example, by projecting an image which includes scale symbols and then adjusting the height, orientation, focus, or other aspects of the projector to align the projected scale symbols with corresponding scale symbols (113) on the workstation (111). For example, suppose that 150 pixels in the CAD drawings equals one foot of real world scale. That is, a component which is 150 pixels long in the CAD drawing would be foot long when fabricated. When the designer views that component on a monitor (105), the 150 pixels will not occupy one-foot of screen space, but rather something much less, perhaps only an inch or less. However, using the present systems and methods, the projector (107) is positioned, oriented, and configured so that when an image with a one foot scale element is projected, the element is actually one foot in length in the projection. Thus, the workstation (111) may have a one-foot scale marking (113) on the surface, and a projection of a one-foot scale marking is projected and the orientation, height, and other configuration of the projector (107) or workstation (111) is aligned, adjusted, or otherwise adapted to cause the scale markings to align so that the projected image is to the real world scale of the design.

Finally, once the projector (107) and workstation (111) are properly scaled, the image to be transferred is projected unto the workstation (111) at real-life scale. The needed markings may then be directly transferred to the table without the need for a designer to calculate the scale and mark out the image. This allows a symbol transfer process that can take an hour or more to be performed in minutes, increasing time efficiency. Once the symbols are transferred, the projection can be turned off.

Although described with respect to fabrication processes, it will be readily apparent from this disclosure that the systems and methods described herein are suitable for use in any circumstance where computer-stored data is desired to be efficiently transferred to a non-computer environment, and in particular, when such transfer is desired to be to scale. These systems and methods are suitable for use with both visual and non-visual data.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A method for transferring a computer-aided drawing comprising:
providing a workstation having a general planar top surface comprising at least one surface scale symbol;
providing a projector disposed at an angle generally perpendicular to said top surface to project light thereon;
providing a computer operatively coupled to said projector;
at said computer, creating a computer-aided drawing;
at said projector, receiving from said computer data indicative of said computer-aided drawing of an object of manufacture having a set of real-world dimensions;
said projector projecting a likeness of said computer-aided drawing on said top surface, said projected likeness including at least one projected scale symbol;
scaling said projected likeness until the dimensions of said projected likeness on said top surface are about the same as said real-world dimensions of said object of manufacture, by aligning said projected scale symbol to said surface scale symbol; and
transferring said scaled projected likeness to said workstation.

2. The method of claim 1, wherein said computer further comprises CAD software and said creating a computer-aided drawing comprises using said CAD software.

3. The method of claim 1, wherein said receiving from said computer data indicative of said computer-aided drawing of an object of manufacture having a set of real-world dimensions comprises receiving a wireless transmission over a network.

4. The method of claim 1, wherein said receiving from said computer data indicative of said computer-aided drawing of an object of manufacture having a set of real-world dimensions comprises receiving data via a wired network.

5. The method of claim 1, wherein said projecting a likeness of said computer-aided drawing on said top surface comprises the use of corrective perspective control.

6. The method of claim 1, wherein said projecting a likeness of said computer-aided drawing on said top surface comprises the use of corrective perspective control.

7. The method of claim 1, wherein said projector is disposed at least 12 feet above said top surface.

8. The method of claim 1, wherein said scaling said projected likeness further comprises adjusting a height of said projector above said top surface.

9. The method of claim 1, wherein said scaling said projected likeness further comprises adjusting said angle of said projector.

10. The method of claim 1, wherein said scaling said projected likeness further comprises adjusting a focus setting of said projector.
